(19) United States
(12) Patent Application Publication
(10) Pub. No.: US 2026/0109812 A1
(43) Pub. Date: Apr. 23, 2026

(54) METHOD FOR PRODUCING POLYHYDROXYALKANOATE AND USE THEREOF

(71) Applicant: KANEKA CORPORATION, Osaka-shi (JP)

(72) Inventor: Masaru HIRANO, Takasago-shi (JP)

(73) Assignee: KANEKA CORPORATION, Osaka-shi (JP)

(21) Appl. No.: 18/993,616

(22) PCT Filed: Aug. 1, 2023
(86) PCT No.: PCT/JP2023/028062

§ 371 Date: Jan. 13, 2025

(30) Foreign Application Priority Data
Aug. 5, 2022 (JP) 2022-125873

(51) Int. Cl. C08G 64/20

(52) U.S. Cl. CPC C08G 64/20

(57) ABSTRACT

An object is to provide a PHA having good thermal stability, even in a pH range in which use of a corrosion-resistant device is not needed. The object is attained by a method for producing a PHA, including: a filter-pressing filtration step including a compression step of compressing an aqueous PHA suspension having a pH of not less than 2.5 and less than 4.0 with use of a filter press; and a through washing step of through-washing a filter cake obtained by the compression step, until the pH becomes 4.0 to 5.5.

### TECHNICAL FIELD

The present invention relates to a method for producing a polyhydroxyalkanoate and use of the polyhydroxyalkanoate.

### BACKGROUND ART

A polyhydroxyalkanoate (hereinafter, also referred to as a “PHA”) is known to be biodegradable.

A PHA produced by microorganisms is accumulated in the microbial cells of the microorganisms. Accordingly, in order to use a PHA as plastic, it is necessary to carry out a step of isolating a PHA from the microbial cells of the microorganisms and purifying the PHA. In the step of isolating and purifying a PHA, the microbial cells of PHA-containing microorganisms are disrupted or the biological components, excluding the PHA, are solubilized, before from an aqueous suspension thus obtained, the PHA is extracted. In this extraction, isolation operations such as, for example, centrifugation, filtration, and drying are carried out. In drying operations, a spray dryer, a fluidized-bed dryer, a drum dryer, or the like is used, and a spray dryer is preferably used because the spray dryer is easy to operate.

In the past, the inventor of the present invention developed a technique of (i) in order to prevent agglutination of a PHA in an aqueous suspension having a pH of not more than 7 and prevent an increase in viscosity, adding an alkylene oxide-based dispersing agent prior to adjusting the pH of the aqueous suspension to not more than 7 and then (ii) spray-drying the obtained aqueous suspension having a pH of not more than 7 (see Patent Literature 1).

Further, Patent Literature 2 discloses, for example, a method for producing a target object, the method including mixing a polyhydroxyalkanoate with acid having a pka of 3 to 10.

### CITATION LIST

### Patent Literature

### Patent Literature 1

International Publication No. 2021/085534

### Patent Literature 2

U.S. Pat. No. 2013/0093119

### SUMMARY OF INVENTION

### Technical Problem

However, a technique regarding a method for producing a PHA as described above has room for further improvement.

Thus, an object of the present invention is to provide a method for producing a PHA having good thermal stability, in a pH range in which use of a corrosion-resistant device is not needed.

### Solution to Problem

The inventor of the present invention conducted diligent studies in order to attain the object, and consequently obtained a novel finding that a PHA having excellent thermal stability is obtained by, in production of the PHA, through-washing a PHA filter cake obtained with use of a filter press, until the pH thereof falls within a specific range. As a result, the inventor of the present invention completed the present invention.

Therefore, an aspect of the present invention is a method for producing a PHA, including a filter-pressing filtration step and a through washing step, the filter-pressing filtration step including a compression step of supplying an aqueous PHA suspension having a pH of not less than 2.5 and less than 4.0 to a filter press and compressing the aqueous PHA suspension, the through washing step is a step of through-washing a filter cake obtained by the compression step, until the filter cake has a pH of 4.0 to 5.5 (hereinafter, the method is referred to as “the present production method”).

An aspect of the present invention is a PHA agglutinate which contains water having a pH of 4.0 to 5.5 and which has a water content of 5.0% to 25.0% (W. B.) (hereinafter, the PHA agglutinate is referred to as “the present PHA agglutinate”).

### Advantageous Effects of Invention

An aspect of the present invention makes it possible to provide a method for producing a PHA that has good thermal stability, without use of a corrosion-resistant device.

### BRIEF DESCRIPTION OF DRAWINGS

FIG. 1 is a graph showing changes in pH and electric conductivity with respect to the ratio of the amount of an aqueous PHA suspension supplied to the amount of washing water used, in Example of the present invention.

FIG. 2 is a graph showing the pH of each aqueous PHA suspension and evaluation of the thermal stability of the obtained pH and YI, in Examples of the present invention.

### DESCRIPTION OF EMBODIMENTS

The following description will discuss an embodiment of the present invention in detail. Note that a numerical range expressed as “A to B” means “not less than A and not more than B”, unless otherwise specified herein.

### 1. Outline of the Present Invention

As a method for producing a PHA, there is known a method in which an aqueous suspension of a PHA is dried. In this method, in order to increase the thermal stability (molecular weight retention rate during heating) of a PHA to be obtained (in other words, suppress degradation of the PHA during heating), it is necessary to lower the pH of an aqueous PHA suspension (generally, a pH of not less than 2.5 and less than 4.0) with use of sulfuric acid or the like. However, in a case where an aqueous PHA suspension having a low pH is used, there is a problem that a device cost is high because a corrosion-resistant device is needed in a drying operation in a step of producing a PHA. In a case where an aqueous PHA suspension having a pH that falls within the range in which no corrosion-resistant device is needed is used, there is a problem that the thermal stability of a PHA to be obtained decreases.

Thus, the inventor of the present invention conducted diligent studies in order to provide a method for producing a PHA which method makes it possible to produce a PHA having good thermal stability without use of a corrosion-resistant device, and consequently found for the first time that, by compressing an aqueous PHA suspension with use of a filter press and through-washing the aqueous PHA suspension, it is possible to produce a PHA having high thermal stability without the need for a corrosion-resistant device.

As a mechanism of the present invention, the inventor of the present invention infers as follows. That is, an aqueous PHA suspension contains metal ions and the like. In a case where such an aqueous PHA suspension is dried in a state where the aqueous PHA suspension has a high pH (for example, not less than 4.0) so that use of a corrosion-resistant device is not needed, the metal ions and the like which remain in an obtained PHA function as a catalyst in the PHA. Therefore, these metal ions and the like promote pyrolysis of the PHA, and thus the thermal stability of the PHA decreases. In contrast, in the present invention, by the above compression and through washing, an aqueous PHA suspension having a low pH is processed into a PHA filter cake, and a solvent containing metal ions and the like in the PHA filter cake is replaced with washing water which does not contain impurities, such as the metal ions, that can function as a catalyst for pyrolysis. By these operations, it is possible to remove the impurities in the PHA filter cake and possible to cause the pH of the PHA filter cake to be not less than 4.0 with which no corrosion-resistant device is needed. Therefore, the present invention makes it possible to produce a PHA having high thermal stability without the need for a corrosion-resistant device.

Note that the term “PHA cake”, “filter cake”, or “PHA filter cake” herein means, for example, a solid composition which is obtained by filtering or compressing an aqueous PHA suspension, which has a water content of more than 25.0% and not more than 50.0%, and which contains a PHA (and which is obtained by agglutination of the PHA in the aqueous PHA suspension). Note also that the term “PHA agglutinate” herein means a solid composition which is obtained by dehydrating a PHA cake by, for example, air blow or the like, which has a water content of 5.0% to 25.0%, and which contains a PHA. The term “PHA powder” herein means, for example, a composition which is obtained by drying a PHA agglutinate, which has a water content of less than 5.0%, and which contains a PHA.

The present production method makes it possible to produce a PHA having good thermal stability, even in a pH range in which use of a corrosion-resistant device is not needed, and is therefore extremely advantageous in production of a PHA. Moreover, the configuration as described above makes it possible to reduce the amount of plastic wastes to be generated. Thus, the present invention can contribute to, for example, attaining the sustainable development goals (SDGs) such as Goal 12 “Ensure sustainable consumption and production patterns” and Goal 14 “Conserve and sustainably use the oceans, seas and marine resources for sustainable development”. The configurations of the present production method and the present aqueous suspension will be described below in detail.

### 2. Method for Producing PHA

The present production method includes the following steps:
a compression step of supplying an aqueous polyhydroxyalkanoate suspension having a pH of not less than 2.5 and less than 4.0 to a filter press and compressing the aqueous polyhydroxyalkanoate suspension; and a through washing step of through-washing a filter cake obtained by the compression step (hereinafter, these steps are referred to as a “step (d)”).

In an embodiment of the present invention, the present production method preferably includes, in addition to the above step (d), at least one of the following steps.
Step (a): a step of disrupting and solubilizing a cell-derived component of a microbial cell which contains a PHA, the cell-derived component being a component other than the PHA, the PHA having a volume median diameter of 0.5 μm to 5.0 μm (the step (a) is also referred to as a “solubilization step”).
Step (b): a step of recovering the aqueous PHA suspension by centrifugation, after the step (a) (the step (b) is also referred to as a “recovery step”).
Step (c′): a step of adjusting the pH of the aqueous PHA suspension obtained in the step (b) to not less than 2.5 and less than 4.0 (the step (c′) is also referred to as an “adjustment step”).
Step (c): a step of heat-treating the aqueous PHA suspension so that the aqueous PHA suspension has a temperature of 60° C. to 120° C. (the step (c) is also referred to as a “heat treatment step”).
Step (e)): a step of drying the PHA obtained in the step (d) at 20° C. to 100° C. (the step (e) is also referred to as a “drying step”).
Step (f): a step of redispersing the dried PHA in an aqueous solvent (the step (f) is also referred to as a “redispersion step”).

In the present production method, the above steps are preferably carried out in the order of the steps (a), (b), (c′), (c), (d), (e), and (f). However, the order can be changed as appropriate, according to purposes. For example, the order of the steps (a) and (b) can be exchanged so that the steps (b) and (a) are carried out in this order, and the order of the steps (c′) and (c) can be exchanged so that the steps (c) and (c′) are carried out in this order. Furthermore, according to purposes, each of the steps (a), (b), (c′), and (c) can be carried out twice or more. That is, for example, the steps (b), (a), and (b) can be carried out in this order or the steps (c′), (c), and (c′) can be carried out in this order. Note that, in the present specification, an aqueous suspension containing at least a PHA may be abbreviated to an “aqueous PHA suspension”.

### (Step (d))

First, the step (d), which is a characteristic configuration of the present invention, is described.

The step (d) of the present production method includes the filter-pressing filtration step and the through washing step. The filter-pressing filtration step includes the compression step of supplying an aqueous PHA suspension having a pH of not less than 2.5 and less than 4.0 to a filter press and compressing the aqueous PHA suspension. The through washing step is a step of through-washing a filter cake obtained by the compression step, until the filter cake has a pH of 4.0 to 5.5. By the step (d), a PHA having high thermal stability is obtained.

A pressure in the compression step in the step (d) is preferably 0.2 MPa to 1.0 MPa, more preferably 0.25 MPa to 0.9 MPa, and even more preferably 0.3 MPa to 0.8 MPa. In a case where the pressure in the compression step is 0.2 MPa to 1.0 MPa, it is possible to wash the PHA filter cake well even with a small amount of washing water.

In the through washing step, the filter cake is washed until the filter cake has a pH of 4.0 to 5.5, preferably 4.1 to 5.4, and more preferably 4.2 to 5.3. In a case where the pH of the filter cake is not less than 4.0, no corrosion-resistant device is needed, particularly, in an air blow step described later. In a case where the pH of the filter cake is not more than 5.5, the thermal stability of the PHA is improved. Note that the pH of the filter cake in the through washing step is difficult to directly measure. Therefore, the pH of a washing liquid (washing filtrate) discharged after the filter cake is washed is measured and regarded as the pH of the filter cake.

In the through washing step, (the amount of the washing water used)/(the amount of the aqueous polyhydroxyalkanoate suspension supplied to a filter chamber of the filter press) is 0.1 to 1.0, preferably 0.12 to 0.98, and more preferably 0.14 to 0.96. In a case where the above value is not less than 0.1, the pH of the PHA filter cake becomes not less than 4.0. In a case where the above value is not more than 1.0, the amount of the washing water contained in the PHA filter cake does not become excessively large, and a PHA agglutinate having a low water content is obtained.

In an embodiment of the present invention, the filter-pressing filtration step in the step (d) includes the air blow step in addition to the compression step. In the compression step, the PHA cake is squeezed by compression so that water is squeezed out from the PHA cake. In the air blow step, water is pressed out from the PHA cake by air-blown air. By subjecting the PHA cake to such a two-step dehydration step, that is, the compression step and the air blow step, it is possible to obtain the PHA agglutinate having a low water content.

An air blow pressure in the air blow step is not particularly limited, and, for example, 0.01 MPa to 1.5 MPa, preferably 0.05 MPa to 1.3 MPa, and more preferably 0.10 MPa to 1.0 MPa. In a case where the air blow pressure falls within the above range, there is an advantage that the PHA agglutinate has a decreased water content.

An air blow duration can be set, as appropriate, in accordance with the air blow pressure, and, for example, 1 minute to 50 minutes and preferably 5 minutes to 40 minutes.

In an embodiment of the present invention, the air blow step can be a through air blow step.

In an embodiment of the present invention, the number of times which each of the filter-pressing filtration step and the through washing step in the step (d) is carried out, the order in which the filter-pressing filtration step and the through washing step in the step (d) are carried out, etc. are not particularly limited. For example, the through washing step may be carried out after the filter-pressing filtration step, or the filter-pressing filtration step may be carried out before and/or after the through washing step.

The filter-pressing filtration step and the through washing step in the step (d) are preferably carried out as follows. That is, a first compression step, the through washing step, a second compression step, and the air blow step are carried out in this order. Carrying out the through washing step after the first compression step causes the washing water to easily pass through the PHA filter cake, and accordingly causes an improvement in washing efficiency. Furthermore, carrying out the second compression step after the through washing step makes it possible to sufficiently discharge the washing water contained in the PHA filter cake.

A pressure in the first compression step in the above embodiment is preferably 0.2 MPa to 0.6 MPa, more preferably 0.25 MPa to 0.55 MPa, and even more preferably 0.3 MPa to 0.5 MPa. A pressure in the second compression step is preferably 0.4 MPa to 1.0 MPa, more preferably 0.5 MPa to 0.9 MPa, and even more preferably 0.6 MPa to 0.8 MPa. It is more preferable that the pressure in the second compression step is higher than that in the first compression step, from the viewpoint of sufficiently removing the washing water.

In an embodiment of the present invention, the filter-pressing filtration step can include a step of supplying a stock solution (aqueous PHA suspension) to the filter chamber, before the compression step.

A device which carries out the filter-pressing filtration is not particularly limited, and can be any publicly known device.

In the present specification, the amount (cm³) of air that passes through a unit area (cm²) of a filter medium per minute is referred to as an air permeability. In the step (d), the air 0.1 permeability is cm³/cm²/min to 2.5 cm³/cm²/min, preferably 0.2 cm³/cm²/min to 2.0 cm³/cm²/min, more preferably 0.3 cm³/cm²/min to 1.8 cm³/cm²/min, even more preferably 0.5 cm³/cm²/min to 1.5 cm³/cm²/min, and particularly preferably 0.8 cm³/cm²/min to 1.2 cm³/cm²/min. In a case where the air permeability falls within the above range, there is an advantage that a rate of leakage of the PHA into a filtrate is low. Note that the air permeability in the compression step of the present production method is measured by the method described in Examples.

The filter medium used in the step (d) is not particularly limited, but can be selected from among various materials such as, for example, paper, filter cloths (woven cloths, non-woven screens, cloths), sintered plates, porcelain filters, polymer membranes, punching metals, and wedge wires. From the viewpoint of price and ease of washing, a filter cloth is preferably used, and a filter cloth having the above described air permeability is more preferably used.

In the step (d), the aqueous PHA suspension has a liquid density of preferably 0.50 g/mL to 1.08 g/mL, more preferably 0.60 g/mL to 1.05 g/mL, even more preferably 0.70 g/mL to 1.03 g/mL, and particularly preferably 0.80 g/mL to 1.02 g/mL. In a case where the liquid density of the aqueous PHA suspension falls within the above range, there is an advantage that a filtrate permeation rate of the aqueous PHA suspension is high and the water content of the PHA agglutinate to be obtained is low. An inferred reason why the filtrate permeation rate decreases in a case where the liquid density is low is as follows: in a case where the aqueous PHA suspension contains air, the air and the PHA interact with each other and consequently the viscosity of the aqueous PHA suspension increases. The liquid density of the aqueous PHA suspension can be adjusted by, for example, including air into the aqueous PHA suspension. In a case where the amount of the air is increased, the liquid density of the aqueous PHA suspension decreases. In a case where the amount of the air is reduced, the liquid density of the aqueous PHA suspension increases.

The filtrate in the step (d) has a solid content concentration of preferably not more than 1,000 mg/L, more preferably not more than 500 mg/L, even more preferably not more than 200 mg/L, and particularly preferably not more than 100 mg/L. In a case where the solid content concentration of the filtrate falls within the above range, there is an advantage that a blockage is unlikely to occurs in a filter cloth. Note that the lower limit is not particularly limited, and may be, for example, 0 mg/mL. Note that the solid content concentration of the filtrate in the present production method is measured by the method described in Examples.

In an embodiment of the present invention, the filter medium is preferably not precoated. In a case where the filter medium is not precoated, there is an advantage that an impurity is unlikely to be mixed in the PHA to be obtained.

The aqueous PHA suspension in the step (d) has a temperature (filtration temperature) of preferably 20° C. to 95° C., more preferably 25° C. to 90° C., even more preferably 30° C. to 85° C., and particularly preferably 35° C. to 70° C. In a case where the temperature of the aqueous PHA suspension falls within the above range, there is an advantage that the filtrate permeation rate is high. An inferred reason for an increase in the filtrate permeation rate is that an increase in the temperature causes an increase in the viscosity of the aqueous PHA suspension and, at the same time, causes an increase in the particle diameter of PHA particles.

In a case where the present production method includes the heat treatment step of the step (c), the temperature of the aqueous PHA suspension during the filtration is lower, by preferably not less than 5° C., more preferably not less than 8° C., even more preferably not less than 10° C., and particularly preferably not less than 12° C., than the temperature of the aqueous PHA suspension after the heat treatment step. In a case where the temperature of the aqueous PHA suspension during the filtration falls within the above range, there is an advantage that it is possible to filer the PHA at a high filtrate permeation rate. A method for decreasing the temperature after the heat treatment step is not particularly limited, and examples thereof include: cooling by a cooling device; and leaving the aqueous PHA suspension to cool.

### (Step (a))

In the step (a) of the present production method, a cell-derived component, other than the PHA, of a microbial cell which contains the PHA is disrupted and solubilized. By disrupting and removing such a microbial cell-derived impurity (cell wall, protein, or the like) through the step (a), it is possible to efficiently recover, from the microbial cell, the PHA having a volume median diameter of 0.5 μm to 5.0 μm.

### <PHA>

As used herein, the term “PHA” is a generic term for polymers each of which contains a hydroxyalkanoic acid as a monomer unit. A hydroxyalkanoic acid which constitutes the PHA is not particularly limited, but examples thereof include 3-hydroxybutanoic acid, 4-hydroxybutanoic acid, 3-hydroxypropionic acid, 3-hydroxypentanoic acid, 3-hydroxyhexanoic acid, 3-hydroxyheptanoic acid, and 3-hydroxyoctanoic acid. The polymers may be homopolymers or copolymers each of which contains two or more types of monomer units.

More specifically, examples of the PHA include poly (3-hydroxybutyrate) (P3HB), poly (3-hydroxybutyrate-co-3-hydroxyhexanoate) (P3HB3HH), poly (3-hydroxybutyrate-co-3-hydroxyvalerate) (P3HB3HV), poly (3-hydroxybutyrate-co-4-hydroxybutyrate) (P3HB4HB), poly (3-hydroxybutyrate-co-3-hydroxyoctanoate) (P3HB3HO), poly (3-hydroxybutyrate-co-3-hydroxyoctadecanoate) (P3HB3HOD), poly (3-hydroxybutyrate-co-3-hydroxydecanoate) (P3HB3HD), and poly (3-hydroxybutyrate-co-3-hydroxyvalerate-co-3-hydroxyhexanoate) (P3HB3HV3HH). Among these examples, P3HB, P3HB3HH, P3HB3HV, and P3HB4HB are preferable because they are easy to industrially produce.

Further, P3HB3HH, which is a copolymer of 3-hydroxybutyric acid and 3-hydroxyhexanoic acid, is more preferable from the following viewpoints: (i) by changing the composition ratio of repeating units, it is possible to cause a change in melting point and crystallinity and consequently cause a change in physical property, such as a Young's modulus or heat resistance, of P3HB3HH, and possible to cause P3HB3HH to have a physical property intermediate between those of polypropylene and polyethylene; and (ii) P3HB3HH is a plastic that is easy to industrially produce as described above and has useful physical properties.

According to an embodiment of the present invention, the composition ratio of repeating units of P3HB3HH is such that the composition ratio of a 3-hydroxybutyrate unit to a 3-hydroxyhexanoate unit is preferably 80/20 (mol/mol) to 99.9/0.1 (mol/mol) and more preferably 85/15 (mol/mol) to 97/3 (mol/mol), from the viewpoint of the balance between plasticity and strength. In a case where the composition ratio of the 3-hydroxybutyrate unit to the 3-hydroxyhexanoate unit is not more than 99.9/0.01 (mol/mol), sufficient plasticity is obtained, In a case where the composition ratio is not less than 80/20 (mol/mol), sufficient hardness is obtained.

The volume median diameter of the PHA in the step (a) is preferably not more than 50 times, more preferably not more than 20 times, and even more preferably not more than 10 times the volume median diameter (hereinafter referred to as a “primary particle diameter”) of primary particles of the PHA. In a case where the volume median diameter of the PHA is not more than 50 times the primary particle diameter, the aqueous PHA suspension exhibits more excellent flowability. Thus, the productivity of the PHA tends to further improve.

According to an embodiment of the present invention, the volume median diameter of the PHA is, for example, preferably 0.5 μm to 5.0 μm, more preferably 1.0 μm to 4.5 μm, and even more preferably 1.2 μm to 4.0 μm, from the viewpoint of achieving excellent flowability. The volume median diameter of the PHA is measured with use of a laser diffraction/scatter particle size distribution meter LA-950 manufactured by HORIBA.

Note that, for convenience, the volume median diameter of the PHA in the steps (a) to (d) generally has a value similar to that of the volume median diameter of the PHA which is defined in the step (a). Therefore, the volume median diameter may be measured in any of the steps (a) to (d).

### <Microbial Cell (Microorganism)>

A microorganism used in the step (a) is not particularly limited, provided that the microorganism can produce the PHA within a cell thereof. For example, it is possible to use a microorganism isolated from nature, a microorganism deposited in a depositary institution (for example, IFO and ATCC) for microbial strains, or a mutant, a transformant, or the like that can be prepared from any of these microorganisms. Examples of a microbial cell that produces P3HB, which is an example of the PHA, include Bacillus megaterium, which is the first P3HB-producing microbial cell discovered in 1925, and also include other natural microorganisms such as Cupriavidus necator (former classification: Alcaligenes eutrophus, Ralstonia eutropha) and Alcaligenes latus. These microorganisms are known to have PHAs accumulated within cells thereof.

Examples of a microbial cell that produces a copolymer of hydroxybutyrate and another hydroxyalkanoate, the copolymer being an example of the PHA, include: Aeromonas caviae, which is a P3HB3HV and P3HB3HH-producing microorganism; and Alcaligenes eutrophus, which is a P3HB4HB-producing microorganism. In particular, regarding P3HB3HH, the microbial cell is more preferably Alcaligenes eutrophus AC32 strain (FERM BP-6038), which has introduced therein genes of a group of PHA synthetases, (T. Fukui, Y. Doi, J. Bacteriol., 179, pp. 4821 to 4830 (1997)), or the like, for the purpose of enhancing the productivity of P3HB3HH. Besides the above, the microbial cell may be of a genetically engineered microorganism which has introduced therein various types of PHA synthesis-related genes selected according to a desired PHA to be produced.

### <Disruption and Solubilization of Cell-Derived Component>

In the step (a), a method for disrupting and solubilizing the cell-derived component, other than the PHA, of the microbial cell which contains the PHA is not particularly limited.

According to an embodiment of the present invention, the above disruption and solubilization are carried out with use of, for example, a lytic enzyme and/or a proteolytic enzyme (e.g., alkaline proteolytic enzyme).

As used herein, the term “lytic enzyme” means an enzyme that has the activity of degrading (lysing) the cell wall (for example, peptidoglycan) of the microbial cell.

According to an embodiment of the present invention, the lytic enzyme is not particularly limited, but examples thereof include lysozyme, labiase, β-N-acetylglucosaminidase, an endolysin, and an autolysin. The lytic enzyme is preferably lysozyme from the viewpoint of economic advantage. One of these lytic enzymes may be used alone, or two or more of these lytic enzymes may be used in combination.

As the lytic enzyme, a commercially available lytic enzyme can also be used. Examples of the commercially available lytic enzyme include “Lysozyme” and “Achromopeptidase” manufactured by FUJIFILM Wako Pure Chemical Corporation.

According to an embodiment of the present invention, the optimum pH of the lytic enzyme is not particularly limited, provided that the lytic enzyme has cell wall degradation activity, but is, for example, 5.0 to 11.0, preferably 6.0 to 9.0, and more preferably 6.0 to 8.0.

According to an embodiment of the present invention, the optimum temperature of the lytic enzyme is not particularly limited, but is preferably not higher than 60° C. and more preferably not higher than 50° C., from the viewpoint of not requiring undue heating and accordingly preventing a thermal change (pyrolysis) of the PHA. The lower limit of the optimum temperature is not particularly limited, but is preferably not lower than room temperature (e.g., 25° C.), from the viewpoint of not requiring an undue cooling operation and therefore being economical.

As used herein, the term “alkaline proteolytic enzyme” means a proteolytic enzyme having the activity of degrading protein in an alkaline environment (e.g., in a solution having a pH of 8.5).

According to an embodiment of the present invention, the alkaline proteolytic enzyme is not particularly limited, provided that the alkaline proteolytic enzyme has the activity of degrading protein in an alkaline environment, but examples thereof include serine-specific proteolytic enzymes (e.g., subtilisin, chymotrypsin, and trypsin), cysteine-specific proteolytic enzymes (e.g., papain, bromelain, and cathepsin), and aspartic acid-specific proteolytic enzymes (e.g., pepsin, cathepsin D, and HIV protease). The alkaline proteolytic enzyme is preferably a serine-specific proteolytic enzyme and, in particular, subtilisin (e.g., alcalase), from the viewpoint of economic advantage. One of these alkaline proteolytic enzymes may be used alone, or two or more of these alkaline proteolytic enzymes may be used in combination.

As the alkaline proteolytic enzyme, a commercially available product can also be used, and examples thereof include: “Alcalase 2.5L” manufactured by Novozyme; “Protin SD-AY10” and “Protease P “Amano” 3SD” manufactured by Amano Enzyme Inc.; “Multifect PR6L” and “Optimase PR89L” manufactured by Danisco Japan Ltd.; “Sumizyme MP” manufactured by Shin Nihon Chemical Co., Ltd.; “Delvolase” manufactured by DSM Japan K.K.; “Biopurase OP”, “Biopurase SP-20FG”, and “Biopurase SP-4FG” manufactured by Nagase ChemteX Corporation; “Orientase 22BF” manufactured by HBI Enzymes Inc.; and “AROASE XA-10” manufactured by Yakult Pharmaceutical Industry Co., Ltd.

According to an embodiment of the present invention, the optimum pH of the alkaline proteolytic enzyme is not particularly limited, provided that the alkaline proteolytic enzyme has activity in an alkaline environment, but is, for example, 8.0 to 14.0, preferably 8.0 to 12.0, more preferably 8.0 to 10.0, even more preferably 8.0 to 9.0, and most preferably 8.5.

According to an embodiment of the present invention, the optimum temperature of the alkaline proteolytic enzyme is not particularly limited, but is preferably not higher than 60° C., and more preferably not higher than 50° C., from the viewpoint of not requiring undue heating and accordingly preventing a thermal change (pyrolysis) of the PHA. The lower limit of the optimum temperature is not particularly limited, but is preferably not lower than room temperature (e.g., 25° C.), from the viewpoint of not requiring an undue cooling operation and therefore being economical.

According to an embodiment of the present invention, the disruption and solubilization of the cell-derived component in the step (a) can be carried out with use of lysozyme and alcalase in combination.

A duration of the above enzyme treatment in the step (a) can vary according to the type, pH, temperature, and/or the like of the enzyme, but is, for example, one hour to eight hours, and preferably two hours to six hours.

Note that a solvent (the “solvent” may also be referred to as an “aqueous medium”) contained in the aqueous PHA suspension in the present production method may be water or a mixed solvent of water and an organic solvent. In the mixed solvent, the concentration of the organic solvent, which is compatible with water, is not particularly limited, provided that the concentration is equal to or lower than the solubility, in water, of the organic solvent used. The organic solvent which is compatible with water is not particularly limited, and examples thereof include: alcohols such as methanol, ethanol, 1-propanol, 2-propanol, 1-butanol, 2-butanol, iso-butanol, pentanol, hexanol, and heptanol; ketones such as acetone and methyl ethyl ketone; ethers such as tetrahydrofuran and dioxane; nitriles such as acetonitrile and propionitrile; amides such as dimethylformamide and acetamide; dimethyl sulfoxide; pyridine; and piperidine. Among these examples, methanol, ethanol, 1-propanol, 2-propanol, 1-butanol, 2-butanol, iso-butanol, acetone, methyl ethyl ketone, tetrahydrofuran, dioxane, acetonitrile, propionitrile, and the like are preferable because they are easy to remove. Further, methanol, ethanol, 1-propanol, 2-propanol, butanol, acetone, and the like are more preferable, because they are easy to obtain. Furthermore, methanol, ethanol, and acetone are particularly preferable. Note that the aqueous medium contained in the aqueous PHA suspension may contain another solvent, a microbial cell-derived component, a compound which is produced during purification, and/or the like, provided that the essentials of the present invention are not impaired.

The aqueous medium contained in the aqueous PHA suspension in the present production method preferably contains water. The amount of the water contained in the aqueous medium is preferably not less than 5% by weight, more preferably not less than 10% by weight, even more preferably not less than 30% by weight, and particularly preferably not less than 50% by weight.

### (Other Steps)

According to an embodiment of the present invention, the present production method may include the following steps before the step (a).

<Step (a1)>

A step (a1) is a step of culturing the microbial cell which contains the PHA.

In the step (a1), the microbial cell described in the section <Microbial cell (microorganism)>above is, for example, used.

In the step (a1), a method for culturing the microbial cell is not particularly limited, but examples thereof include the method described in paragraphs 0041 to 0048 of the International Publication No. WO 2019/142717.

<Step (a2)>

A step (a2) is a step of inactivating microbial cells obtained in the step (a1). In this step, the microbial cells obtained in the step (a1) are inactivated to obtain an inactivated culture solution.

In the step (a2), a method for inactivating the microbial cells is not particularly limited, but examples thereof include a method in which a culture solution that contains the microbial cells containing, for example, P3HA is heated and stirred at the temperature of the culture solution of 60° C. to 70° C. for 7 hours.

<Step (a3)>

A step (a3) is a step of adjusting the concentration and pH of the inactivated culture solution obtained in the step (a2). The step (a3) is mainly carried out in a case where the viscosity of the inactivated culture solution obtained in the step (a2) is high, and the concentration and pH of the inactivated culture solution are adjusted so that the viscosity of the inactivated culture solution is reduced. The step (a3) facilitates the solubilization of the cell-derived component in the step (a).

A method for adjusting the concentration and pH of the inactivated culture solution in the step (a3) is not particularly limited, but the adjustment is carried out by any method used in this technical field. For example, by adding hydrogen peroxide or the like to the inactivated culture solution, it is possible to adjust the concentration of the inactivated culture solution. Examples of a method for adjusting the pH include a method in which a basic compound is added to the inactivated culture solution. The basic compound is not particularly limited, but is preferably an alkali metal hydroxide or an alkaline-earth metal hydroxide, and more preferably sodium hydroxide. One of these basic compounds may be used alone, or two or more of these basic compounds may be used in combination.

### (Step (b))

In the step (b) of the present production method, the aqueous PHA suspension is recovered by centrifugation after the step (a). By the step (b), it is possible to remove the microbial cell-derived impurity (cell wall, protein, or the like) contained in the aqueous PHA suspension.

In the step (b), the recovery of the aqueous PHA suspension is carried out by any centrifugation method publicly known in this technical field. The centrifugation method is not particularly limited, but examples thereof include centrifugation with use of a centrifugal settler, a centrifugal dehydrator, or the like.

Examples of the centrifugal settler include centrifugal settlers of a separation plate type (such as disc type, self-cleaning type, nozzle type, screw decanter type, or skimming type), a cylinder type, and a decanter type. According to a sediment component discharging method, each of the centrifugal settlers is categorized into a batch-wise centrifugal settler or a continuous centrifugal settler. Similarly, the centrifugal dehydrator is categorized into a batch-wise centrifugal dehydrator or a continuous centrifugal dehydrator. By using any of these devices, it is possible to separate a sediment containing the PHA from a culture solution component due to a difference in specific gravity.

Since the amount of impurities which are to remain in an end product depends mainly on the steps (a) and (b), it is preferable to reduce the impurities to the smallest possible amount. As a matter of course, in some uses, the impurities may be mixed in the end product to the extent that the physical properties of the end product are not impaired. However, in a case where a highly pure PHA is required for, for example, medical use, it is preferable to reduce the impurities to the smallest possible amount. An index of the degree of purification in reducing the impurities can be, for example, the amount of PHA surface adhesion protein contained in the aqueous PHA suspension. The amount of this protein with respect to the weight of the PHA is not more than 2,000 ppm, preferably not more than 1,900 ppm, more preferably not more than 1,800 ppm, and most preferably not more than 1,700 ppm. In a case where the amount of the PHA surface adhesion protein in the aqueous PHA suspension falls within the above range, there is an advantage that the rate of leakage ratio is not excessively high. An inferred reason why this effect is brought about is that, in a case where the amount of the PHA surface adhesion protein is small, PHAs easily gather.

(Step (c′))

In the step (c′), the aqueous PHA suspension recovered by centrifugation usually has a pH greater than 7. In the step (c′) of the present production method, the pH of the aqueous PHA suspension obtained in the step (b) is adjusted to not less than 2.5 and less than 4.0. Carrying out the pH adjustment of the step (c′) reduces the rate of leakage in the filtration of the step (d).

In the step (c′), the pH of the aqueous PHA suspension is not less than 2.5 and less than 4.0, preferably 2.6 to 3.9, more preferably 2.7 to 3.8, even more preferably 2.8 to 3.7, and particularly preferably 2.9 to 3.6. In a case where the pH of the aqueous PHA suspension falls within the above range, there is an advantage that, in the filtration step, it is possible to improve the filtrate permeation rate without increasing the rate of leakage of the PHA into the filtrate. An inferred reason why this effect is brought about is that PHAS have a particle diameter which is not excessively small and thus the PHAs easily agglutinate. The upper limit of the pH is preferably less than 4.0, from the viewpoint of reducing coloration during heating and melting of the PHA, the viewpoint of ensuring the stability of the molecular weight of the PHA during heating and/or drying, and the viewpoint of obtaining the PHA of which coloration during the heating and the melting has been reduced and of which the reduction in the molecular weight during the heating and/or the drying has been prevented. The lower limit of the pH is preferably not less than 2.5, from the viewpoint of the acid resistance of a container.

In the step (c′), a method for adjusting the pH is not particularly limited, but examples thereof include a method in which acid is added. The acid is not particularly limited, but may be either an organic acid or an inorganic acid, and may or may not be volatile. More specifically, examples of the acid can include sulfuric acid, hydrochloric acid, phosphoric acid, and acetic acid.

In the step (c′), the aqueous PHA suspension is preferably heated. A heating temperature is not particularly limited, but is, for example, preferably 40° C. to 90° C., more preferably 50° C. to 80° C., and more preferably 60° C. to 70° C. Heating the aqueous PHA suspension in the step (c′) facilitates adjustment of the pH. Therefore, it is possible to obtain a highly thermally stable PHA.

According to an embodiment of the present invention, it is preferable that an additional pH adjustment should not be carried out after the pH adjustment in the step (c) and until after the step (d) is carried out.

### (Step (c))

In the step (c) of the present production method, the aqueous PHA suspension is heat-treated so that the aqueous PHA suspension has a temperature of 60° C. to 120° C. With the step (c), it is possible to increase the filtrate permeation rate during the filtration.

In the step (c), the aqueous PHA suspension is heat-treated so that the aqueous PHA suspension has a temperature of preferably 60° C. to 120° C., more preferably 62° C. to 118° C., and even more preferably 65° C. to 115° C. In a case where the temperature of the aqueous PHA suspension falls within the above range, it is possible to further increase the filtrate permeation rate during the filtration.

A method for heat-treating the aqueous PHA suspension in the step (c) is not particularly limited, but examples thereof include (i) a method in which steam is used to warm the container holding the aqueous PHA suspension, (ii) a method in which oil is used to warm the container holding the aqueous PHA suspension, and (iii) a method in which steam is directly put into the aqueous PHA suspension. The temperatures of the steam in (i) and (iii) and the temperature of the oil in (ii) are not particularly limited, provided that these temperatures cause the aqueous PHA suspension to have a temperature of 60° C. to 120° C. in the step (c). For example, the temperatures are 95° C. to 150° C.

### (Step (e))

In the step (e) of the present production method, the PHA obtained in the step (d) is dried at 20° C. to 100° C. With the step (e), it is possible to evaporate the water contained in the aqueous PHA suspension, and possible to adjust the water content.

A method for drying the PHA in the step (e) is not particularly limited, but examples thereof include: heating; vacuum drying; and drying at normal temperature. The drying is preferably carried out by heating, from the viewpoint of a moderate drying speed. A heating medium (e.g., hot air or a jacket) during the drying is preferably at 30° C. to 90° C., more preferably at 40° C. to 80° C., and even more preferably at 50° C. to 70° C.

### (Step (f))

In the step (f) of the present production method, the dried PHA is redispersed in an aqueous solvent to obtain an aqueous PHA suspension. By carrying out the step (f) after the step (e), obtained is an aqueous PHA suspension containing the PHA which has a particle diameter substantially the same as the original particle diameter (primary particle diameter).

In the step (f), a method for redispersing the PHA is not particularly limited, and the redispersion is carried out by any method used in this technical field.

In the step (f), the volume median diameter of the PHA is not particularly limited, provided that the volume median diameter is substantially the same as the volume median diameter of the PHA in the step (a). For example, the volume median diameter is preferably 0.5 μm to 5.0 μm, more preferably 1.0 μm to 4.5 μm, and even more preferably 1.2 μm to 4.0 μm. As used herein, the expression “volume median diameter is substantially the same” means that the difference from the volume median diameter of the PHA in the step (a) is not more than 1.0 μm.

The steps (e) and (f) may be carried out successively. That is, the PHA dried in the step (e) may be redispersed in the step (f) to obtain the aqueous PHA suspension. According to an embodiment of the present invention, the present production method includes: a step of drying, at 20° C. to 100° C., the polyhydroxyalkanoate obtained in the filtration step; and a step of redispersing the dried polyhydroxyalkanoate in an aqueous solvent to obtain an aqueous polyhydroxyalkanoate suspension which contains the polyhydroxyalkanoate having a volume median diameter of 0.5 μm to 5.0 μm.

### [3. PHA Agglutinate]

The present PHA agglutinate contains water having a pH of 4.0 to 5.5, and has a water content of 5.0% to 25.0% (W. B.).

The pH of the present PHA agglutinate is 4.0 to 5.5, preferably 4.1 to 5.4, and more preferably 4.2 to 5.3.

The water content of the present PHA agglutinate is 5.0% to 25.0% (W. B.), preferably 5.5% to 23.0% (W. B.), more preferably 6.0% to 21.0% (W. B.), even more preferably 6.5% to 20.0% (W. B.), and particularly preferably 7.0% to 19.0% (W. B.). In a case where the water content of the present PHA agglutinate falls within the above range, the PHA agglutinate becomes not a slurry state but a solid state, and thus there is an advantage that the PHA agglutinate is easy to put into a dryer. Note that the water content of the present PHA agglutinate is measured by the method described in Examples.

According to an embodiment of the present invention, the present PHA agglutinate is produced by the present production method.

The present PHA agglutinate may contain various components which have been produced in the course of the present production method or could not have been removed, provided that the present PHA agglutinate has the effect of the present invention.

The present PHA agglutinate can be used for various purposes such as paper, films, sheets, tubes, plates, rods, containers (e.g. bottle containers), bags, and components.

The present PHA agglutinate may be dried by a publicly known method to obtain a PHA powder. The thermal stability of the PHA powder obtained from the present PHA agglutinate is preferably not less than 70%, more preferably not less than 75%, and even more preferably not less than 80%. In a case where the thermal stability is not less than 70%, it is possible to prevent a deterioration of a resin to be obtained by processing the PHA powder. The higher the thermal stability, the better, and the upper limit is not particularly limited. For example, the thermal stability is not more than 99%, and may be 100%. The thermal stability is expressed by the following formula (2) on the basis of the method described in Examples below.

$$The therm al stability ( \% ) = the weight average molecular weight of a polygydroxyalkanoate sheet obtained by pressing the polyhydroxyalkanoate powder at 160 ° C . and 5 MPa for 20 minutes / the weight average molecular weight of the polyhydroxyalkanoate powder \times 100 \qquad ( 2 )$$

The PHA powder is preferably one in which coloration during heating is reduced. The degree of the coloration of the PHA powder can be evaluated by the YI (yellowness index) of a pressed sheet obtained by pressing the PHA powder. It can be evaluated that, as the value of the YI of the pressed sheet becomes lower, the coloration of the PHA powder is reduced more. Note that a more specific method for evaluating the degree of the coloration of the PHA powder is as described in Examples.

The present invention is not limited to the embodiments, but can be altered by a skilled person in the art within the scope of the claims. The present invention also encompasses, in its technical scope, any embodiment derived by combining technical means disclosed in differing embodiments.

That is, aspects of the present invention include the following.

<1>A method for producing a polyhydroxyalkanoate, including
a filter-pressing filtration step and
a through washing step,
the filter-pressing filtration step including a compression step of supplying an aqueous polyhydroxyalkanoate suspension having a pH of not less than 2.5 and less than 4.0 to a filter press and compressing the aqueous polyhydroxyalkanoate suspension,
the through washing step including a step of through-washing a filter cake obtained by the compression step, until the filter cake has a pH of 4.0 to 5.5.

<2> The method as described in <1>, wherein the filter-pressing filtration step further includes an air blow step.

<3> The method as described in <1> or <2>, wherein, in the filter-pressing filtration step and the through washing step, a first compression step, the through washing step, a second compression step, and an air blow step are carried out in this order.

<4> The method as described in any one of <1> through <3>, wherein, in the through washing step, (an amount of washing water used)/(an amount of the aqueous polyhydroxyalkanoate suspension supplied to a filter chamber of the filter press) is 0.1 to 1.0.

<5> The method as described in any one of <1> through <4>, wherein, in the filter-pressing filtration step, a filter cloth having an air permeability of 0.1 cm³/cm²/min to 2.5 cm³/cm²/min is used.

<6> The method as described in any one of <1> through <5>, wherein the aqueous polyhydroxyalkanoate suspension has a temperature of 20° C. to 95° C. in the compression step.

<7> The method as described in any one of <1> through <6>, further including
a step (a) of disrupting and solubilizing a cell-derived component of a microbial cell which contains a polyhydroxyalkanoate, the cell-derived component being a component other than the polyhydroxyalkanoate,
the polyhydroxyalkanoate having a volume median diameter of 0.5 μm to 5.0 μm in the step (a).

<8> The method as described in any one of <1> through <7>, further including, after the step (a), a step (b) of recovering the aqueous polyhydroxyalkanoate suspension by centrifugation.

<9> The method as described in any one of <1> through <8>, further including a step of drying, at 20° C. to 100° C., a polyhydroxyalkanoate obtained by the filtration step.

<10> The method as described in any one of <1> through <9>, wherein a pressure in the compression step is 0.2 MPa to 1.0 MPa.

<11> The method as described in any one of <1> through <10>, wherein an air blow pressure in the air blow step is 0.01 MPa to 1.5 MPa.

<12>A method for producing an aqueous polyhydroxyalkanoate suspension, including a step of dispersing, in an aqueous solvent, a polyhydroxyalkanoate produced by a method described in any one of <1> through <11 >.

<13>A polyhydroxyalkanoate agglutinate which contains water having a pH of 4.0 to 5.5 and which has a water content of 5.0% to 25.0% (W. B.).

<14>A polyhydroxyalkanoate powder which is obtained by drying a polyhydroxyalkanoate agglutinate described in <13> and which has thermal stability of not less than 70%, the thermal stability being expressed by the following formula (2):

$$the therm al stability ( \% ) = the weight average molecular weight of a polyhydroxyalkanoate sheet obtained by pressing the polyhydroxyalkanoate powder at 160 ° C . and 5 MPa for 20 minutes / a the weight average molecular weight of the polyhydroxyalkanoate powder \times 100. \qquad ( 2 )$$

### EXAMPLES

The following description will discuss the present invention in more detail on the basis of Examples. However, the present invention is not limited to Examples. In Examples, “P3HB3HH” is used as the “PHA”. The term “PHA” in Examples can therefore be read as “P3HB3HH”.

### [Measurement Method]

Measurements in Examples and Comparative Examples were carried out by the following methods.

### (Thermal Stability of PHA Powder)

As an evaluation sample, a PHA agglutinate obtained in each of Examples and Comparative Examples below was used. The PHA agglutinate was put in a dryer (WFO-700, manufactured by EYELA), and dried at 60° C. for 24 hours to obtain a PHA powder. The obtained PHA powder was preheated at 160° C. for 7 minutes, and then pressed at 5 MPa for 20 minutes to prepare a PHA sheet. After 10 mg of this PHA sheet was dissolved in 10 mL of chloroform, insoluble matter was removed by filtration. The molecular weight of this solution (filtrate) was measured with use of (i) a GPC system which is manufactured by Shimadzu Corporation and which is equipped with “Shodex K805L (300 mm×8 mm, two columns connected)” (manufactured by Showa Denko K.K.) and (ii) chloroform as a mobile phase. As a molecular weight standard sample, a commercially available standard polystyrene was used. The molecular weight of the PHA powder was measured by a similar procedure, except that a PHA sheet was not prepared.

Thermal stability was evaluated on the basis of the following formula (2).

$$The therm al stability ( \% ) = the weight average molecular weight of the PHA sheet obtained by pressing the PHA powder at 160 ° C . and 5 MPa for 20 minutes / the weight average molecular weight of the PHA powder \times 100 \qquad ( 2 )$$

### (YI (Yellowness Index))

A pressed sheet of a PHA resin, which pressed sheet was a YI value measurement sample, was prepared by the following method. That is, 3.0 g of the PHA powder was sandwiched between 15-cm square metal plates. Metal plates each having a thickness of 0.5 mm were further inserted between the 15-cm square metal plates so as to be located at respective four corners thereof. The PHA powder thus sandwiched was set in a small-sized pressing machine for experiments (H-15 type, manufactured by Takabayashi Rika Co., Ltd.). The PHA was preheated at 160° C. for 7 minutes, and then pressed at 5 MPa for 2 minutes while being heated.

After the press, the PHA was left to stand at room temperature so that the PHA was cured. In this manner, the pressed sheet of the PHA resin was prepared. A YI value was measured with use of a color difference meter “SE-2000” (manufactured by NIPPON DENSHOKU INDUSTRIES CO., LTD.) with a 30-mm measurement plate.

### (Water Content of PHA Agglutinate)

A dehydrated cake produced in a test was cut into three or nine pieces so as to collect an appropriate amount of a piece from the dehydrated cake. Subsequently, the piece was dried in a constant-temperature drier at 105° C. for approximately 15 hours, and the water content of the PHA agglutinate was calculated from the difference in mass of the piece between before and after drying.

### (Solid Content Concentration)

The solid content concentration of an aqueous PHA suspension was measured with use of a heat drying type moisture analyzer ML-50 (manufactured by A&D Company, Limited). The aqueous PHA suspension was heated at 105° C. until the rate of change in weight fell below 0.05%/min, and the solid content concentration thereof was calculated from the change in the weight of the aqueous PHA suspension before and after the heating.

### (Volume Median Diameter)

The volume median diameter of a PHA was measured with use of a laser diffraction/scatter particle size distribution meter LA-950 manufactured by HORIBA.

(pH of Aqueous PHA Suspension in Step (c′))

A pH was measured with use of a pH meter (9652-10D, manufactured by HORIBA). The pH was measured at a position in the aqueous PHA suspension, the position being the farthest from a position where acid was added, the aqueous PHA suspension having been brought into a fluidized state with use of a stirring blade or the like. For example, in a case where acid was added at the wall surface of a container, the pH was measured at the center of the container.

### Example 1

### (Preparation of Microbial Cell Culture Solution)

Ralstonia eutropha described in the International Publication No. WO 2019/142717 was cultured by the method described in paragraphs 0041 to 0048 of the same document, so that a microbial cell culture solution containing microbial cells which contained a PHA was obtained. Note that Ralstonia eutropha is currently classified as Cupriavidus necator.

### (Inactivation)

The microbial cell culture solution obtained as described above was heated and stirred at the temperature of the microbial cell culture solution of 60° C. to 70° C. for 7 hours for sterilization. An inactivated culture solution was thus obtained.

### (Viscosity Reduction Treatment)

To the inactivated culture solution obtained as described above, 35% by weight hydrogen peroxide (manufactured by FUJIFILM Wako Pure Chemical Corporation) was added such that the hydrogen peroxide was 1% by weight of the inactivated culture solution. Next, a 30% aqueous sodium hydroxide solution was added so that the pH of the inactivated culture solution was adjusted to 11.0. By keeping on adding the 30% aqueous sodium hydroxide solution while maintaining the solution at 60° C., the pH of the solution was maintained at 11.0 for 180 minutes. An aqueous PHA suspension was thus obtained.

### (Enzyme Treatment)

To the aqueous PHA suspension obtained as described above, 95% sulfuric acid was added so that the pH of the aqueous PHA suspension was adjusted to 7.0±0.2. The solid content concentration of the aqueous PHA suspension having sulfuric acid added thereto was measured, and found to be 30% by weight. After the addition of the sulfuric acid, Lysozyme (manufactured by FUJIFILM Wako Pure Chemical Corporation), which is an enzyme that degrades sugar chains (peptidoglycan) in a cell wall, was added so that the concentration thereof in the aqueous PHA suspension was 10 ppm, and the aqueous PHA suspension was kept at 50° C. for 2 hours. After that, Alcalase 2.5L (manufactured by Novozyme), which is a proteolytic enzyme, was added so that the concentration thereof in the aqueous PHA suspension was 300 ppm. Then, 30% sodium hydroxide was added at 50° C. so that the pH of the aqueous PHA suspension was adjusted to 8.5. While such adjustment was carried out, the pH was maintained for 2 hours.

### (Alkaline Treatment)

Sodium dodecyl sulfate (SDS, manufactured by Kao Corporation) was added to the above enzyme-treated solution so as to be 0.3% by weight of the enzyme-treated solution. After that, the pH of the enzyme-treated solution was adjusted to 11.0±0.2 with use of an aqueous sodium hydroxide solution. Next, the enzyme-treated solution was centrifuged (4,000 G, 10 minutes), and a supernatant was A twofold concentrated aqueous PHA then removed. suspension was thus obtained. Subsequently, the following operation was repeated 4 times: adding, to this concentrated aqueous PHA suspension, sodium hydroxide in an amount equal to that of the removed supernatant; centrifuging the aqueous PHA suspension again (4,000 G, 10 minutes); and removing a supernatant. The volume median diameter of the PHA was 2.2 μm.

### (pH Adjustment)

The solid content concentration of the aqueous PHA suspension obtained as described above was adjusted to 25% by weight, and the aqueous PHA suspension was then kept at 60° C. Next, the pH was adjusted to 3.5 by adding 10% sulfuric acid. The liquid density was 1.00 g/mL.

### (Filter-Pressing Filtration and Through Washing)

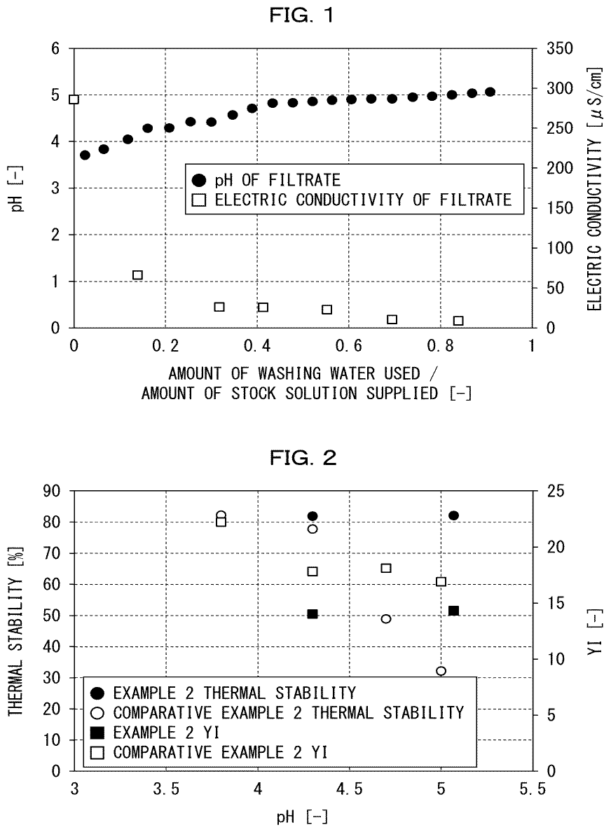

The aqueous PHA suspension was put in a water bath at 63° C., heated so as to have a temperature of 60° C., and filtered with use of a filter press (ISD type 360, manufactured by ISHIGAKI COMPANY, LTD.). A filter cloth having an air permeability of 1.0 cm³/cm²/min (IP196C-1, manufactured by ISHIGAKI COMPANY, LTD.) was used. After a filter cake was obtained by carrying out compression at a pressure of 0.4 Mpa, the filter cake was through-washed until the pH of the filter cake became 5.07 with washing water and (the amount of the washing water used)/(the amount of the aqueous polyhydroxyalkanoate suspension supplied to a filter chamber of the filter press) became 0.91. After the washing, compression was carried out again at a pressure of 0.7 MPa, and air blow was carried out at an air blow pressure adjusted to 0.4 Mpa for 20 minutes to obtain a filter cake. FIG. 1 shows the pH and the electric conductivity of a washing filtrate. Table 1 shows the physical properties of the obtained filter cake. The water content of the filter cake was 13.5 wt % (W. B.).

### Comparative Example 1

A filter cake was obtained in a manner similar to that in Example 1, except that through washing was not carried out. Table 1 shows the physical properties of the obtained filter cake. The water content of the filter cake was 11.5 wt % (W. B.).

TABLE 1

| | Washing | YI [—] | Thermal Stability [%] |
|---|---|---|---|
| Example 1 | Washed | 14.3 | 82.1 |
| Comparative | Not washed | 18.0 | 78.1 |
| Example 1 | | | |

As is clear from Table 1, the YI in Example 1, in which the washing was carried out, was lower than that in Comparative Example 1, in which the washing was not carried out. Moreover, the thermal stability in Example 1 was higher than that in Comparative Example 1. FIG. 1 is a graph showing changes in the pH and the electric conductivity of the washing filtrate with respect to the ratio between the amount of the washing water used and the amount of the aqueous PHA suspension supplied. It is found from FIG. 1 that, as the amount of the washing water used increases, the pH of the washing filtrate increases and the electric conductivity of the washing filtrate decreases. Note that the term “stock solution” in FIG. 1 means the aqueous PHA suspension. It is found from the result shown in FIG. 1 that a solvent derived from the aqueous PHA suspension contained in the PHA filter cake is replaced with the washing water by continuing the washing.

The above showed that the present production method caused an improvement in the thermal stability of a PHA to be obtained. Moreover, it was found that this effect was brought about because a solvent in a PHA filter cake was removed by washing.

### Example 2

A filter cake was obtained in a manner similar to that in Example 1, except that the through washing step was carried out until the pH of the filter cake became 4.3 and (the amount of washing water used)/(the amount of an aqueous polyhydroxyalkanoate suspension supplied to a filter chamber of a filter press) became 0.25 or the pH of the filter cake became 5.1 and (the amount of the washing water used)/(the amount of the aqueous polyhydroxyalkanoate suspension supplied to the filter chamber of the filter press) became 0.91. The water content of the filter cake was 12.9 wt % (W. B.). Table 2 and FIG. 2 show the YI and the thermal stability of the obtained filter cake.

### Comparative Examples 2-1 to 2-4

A PHA slurry was obtained in a manner similar to that in Example 1, except for the operations following the pH adjustment, that is, except that the filter-pressing filtration step and the through washing step were not carried out and water contained in an aqueous PHA suspension was entirely volatilized. Table 2 and FIG. 2 show the YI and the thermal stability of the obtained PHA slurry.

TABLE 2

| | pH[—] | Thermal Stability [%] | YI [—] |
|---|---|---|---|
| Example 1 | 5.1 | 82.1 | 14.3 |
| Example 2 | 4.3 | 81.9 | 14.0 |
| Comparative | 3.8 | 82.2 | 22.2 |
| Example 2-1 | | | |
| Comparative | 4.3 | 77.7 | 17.8 |
| Example 2-2 | | | |
| Comparative | 4.7 | 48.9 | 18.1 |
| Example 2-3 | | | |
| Comparative | 5.0 | 32.1 | 16.9 |
| Example 2-4 | | | |

As is clear from Table 2 and FIG. 2, the thermal stability of the PHAs produced by the present production method in Examples 1 and 2 was higher than that of the PHAs in Comparative Examples 2-3 and 2-4, in which the filter-pressing filtration step and the through washing step were not carried out. Furthermore, the YI of the PHAs in Examples 1 and 2 was lower than that of the PHAs in Comparative Examples 2-1 to 2-4. Note that the thermal stability in Comparative Example 2-1 is equivalent to that in Examples 1 and 2 but the pH in Comparative Example 2-1 is as low as 3.8 and therefore a corrosion-resistant device is needed for production.

### Example 3

A PHA agglutinate obtained in Example 1 was placed in a dryer (WFO-700, manufactured by EYELA) and dried at 60° C. for 24 hours. The dried PHA agglutinate was redispersed in water, and the solid content concentration was adjusted to 15% by weight. The pH was adjusted between 7 and 9 with use of a 1% NaOH aqueous solution and a 1% H₂SO₄ aqueous solution, and the PHA agglutinate redispersed in the water was then stirred. An aqueous PHA suspension was thus prepared. The particle diameter of PHA particles in the aqueous PHA suspension was measured after 30 minutes of stirring, and the volume median diameter was found to be 2.8 μm.

### SUMMARY

It was found from the above that the present production method allowed obtainment of a PHA having good thermal stability, even in a pH range in which use of a corrosion-resistant device is not needed, i.e., with a pH of not less than 4.0.

### INDUSTRIAL APPLICABILITY

The present production method makes it possible to produce a PHA having good thermal stability, even in a pH range in which use of a corrosion-resistant device is not needed. Thus, it is possible to advantageously use the present production method in production of a PHA.

Furthermore, it is possible to suitably use the present PHA agglutinate in the fields of agriculture, fishery, forestry, horticulture, medicine, sanitary products, clothing, non-clothing, packaging, automobiles, building materials, and the like.

1. A method for producing a polyhydroxyalkanoate, the method comprising:
a filter-pressing filtration and
a through washing,
wherein the filter-pressing filtration comprises supplying an aqueous polyhydroxyalkanoate suspension having a pH of from 2.5 and less than 4.0 to a filter press and compressing the aqueous polyhydroxyalkanoate suspension, and
wherein the through washing comprises through washing a filter cake obtained by the compressing, until the filter cake has a pH of from 4.0 to 5.5.

2. The method as set forth in of claim 1, wherein the filter-pressing filtration further comprises air blowing.

3. The method of claim 2, wherein, in the filter-pressing filtration and the through washing, a first compression, the through washing, a second compression step, and the air blow are carried out in this order.

4. The method of claim 1, wherein, in the through washing, a ratio of an amount of washing water to an amount of the aqueous polyhydroxyalkanoate suspension supplied to a filter chamber of the filter press is from 0.1 to 1.0.

5. The method of claim 1, wherein, in the filter-pressing filtration, a filter cloth having an air permeability of from 0.1 cm³/cm²/min to 2.5 cm³/cm²/min is used.

6. The method of claim 1, wherein the aqueous polyhydroxyalkanoate suspension has a temperature of from 20° C. to 95° C. in the compressing.

7. The method of claim 1, further comprising:
(a) disrupting and solubilizing a cell-derived component of a microbial cell which contains comprises a polyhydroxyalkanoate, wherein the cell-derived component is a component other than the polyhydroxyalkanoate,
wherein the polyhydroxyalkanoate has a volume median diameter of from 0.5 μm to 5.0 μm in the (a).

8. The method as set forth in of claim 7, further comprising, after the (a), (b) recovering the aqueous polyhydroxyalkanoate suspension by centrifugation.

9. The method of claim 1, further comprising drying a polyhydroxyalkanoate obtained by the filter-pressing filtration step and the through washing at a temperature of from 20° C. to 100° C.

10. The method of claim 1, wherein a pressure in the compressing is from 0.2 MPa to 1.0 MPa.

11. The method of claim 2, wherein an air blow pressure in the air blow is from 0.01 MPa to 1.5 MPa.

12. A method for producing an aqueous polyhydroxyalkanoate suspension, the method comprising:
obtaining a polyhydroxyalkanoate by the method of claim 1; and
redispersing the obtained polyhydroxyalkanoate in an aqueous solvent.

13-14. (canceled)
